(19) United States
(12) Patent Application Publication
(10) Pub. No.: US 2010/0143001 A1
(43) Pub. Date: Jun. 10, 2010

(54) TONER CARTRIDGE

(75) Inventors: Chin-His CHUANG, Changhua County (TW); Chen-Che CHEN, Changhua County (TW); Hui-Yin WANG, Taichung County (TW); Xiao-Hui WANG, Taichung County (TW); Yo-Sin WANG, Taichung County (TW)

Correspondence Address: BROWDY AND NEIMARK, P.L.L.C.;624 NINTH STREET, NW, SUITE 300, WASHINGTON, DC, 20001-5303, US

(73) Assignee: GENERAL PLASTIC INDUSTRIAL CO. LTD., Taichung County (TW)

(21) Appl. No.: 12/331,077

(22) Filed: Dec. 9, 2008

(51) Int. Cl. G03G 15/08

(52) U.S. Cl. 399/262

(57) ABSTRACT

A toner cartridge includes a housing, a wheel and a grating tube. The housing has a chamber for accommodation of toner, and an outlet in communication between the chamber and the outside. The wheel is rotatably connected the housing. The grating tube is coaxially connected to the wheel and defines several transparent areas and several opaque areas. The grating tube is made of transparent material and covered with several opaque layers defining the opaque areas such that the toner cartridge has the advantages of flexible application, being compatible with different types of image-forming apparatuses, and reducing manufacturing cost.

### BACKGROUND OF THE INVENTION

1. Field of the Invention

The present invention relates generally to an electrical image-forming apparatus and more specifically, to a toner cartridge which is compatible with different types of image-forming apparatuses and the manufacturing cost thereof can be reduced.

2. Description of the Related Art

A conventional toner cartridge, as disclosed in FIGS. 2, 6 and 7 of U.S. Patent Publication No. 2007/0269225, includes a cartridge main body 501a, a driving member 501j connected to a conveying member 501i, and a driven member 501l driven by the driving member 501j and connected to an agitating member 501k. When the toner cartridge is installed in an image-forming apparatus, such as a photostat, the driving member 501j and the conveying member 501i can be driven to rotate synchronously by actuation of the image-forming apparatus, such that the conveying member 501i can convey toner that is accommodated in the cartridge main body 501a toward a discharging unit 501g. The agitating member 501k can be driven to agitate the toner by the driven member 501l that is actuated by the driving member 501j for preventing agglomeration of the toner.

In order to confirm that the toner cartridge is working in normal operation, the toner cartridge further includes a rotational body 501v connected to the driven member 501l and having a plurality of slots. When the driven member 501l is rotated, the light generated from a light emitting element 702a that is located inside the rotational body 501v are intermittently received by a light receiving element 702b that is located outside the rotational body 501v through the slots of the rotational body 501v. Therefore, it can be ascertained whether the toner cartridge is working in normal operation or not according to time interval of the light received by the light receiving element 702b.

However, the rotational body 501v is integrally connected to the driven member 501l so that a mold for the rotational body 501v and the driven member 501l will be difficult to manufacture, causing high manufacturing cost. Furthermore, the rotational body 501v isn't essential for all types of toner cartridges, and the rotational body 501v with different number of the slots is supplied to match different types of the image-forming apparatuses. As a result, a manufacturer needs to prepare different molds to satisfy different needs of different types of the image-forming apparatuses, further causing increase of the manufacturing cost of toner cartridge. Thus, there is a need to provide an improved toner cartridge that does not have the aforesaid drawbacks.

### SUMMARY OF THE INVENTION

The present invention has been accomplished in view of the above-noted circumstances. It is therefore one objective of the present invention to provide a toner cartridge, which can be compatible with different types of image-forming apparatuses.

It is therefore another objective of the present invention to provide a toner cartridge, which can reduce manufacturing cost.

To achieve these objectives of the present invention, the toner cartridge comprises a housing, a wheel and a grating tube. The housing has a chamber for accommodation of toner, and an outlet in communication between the chamber and the outside. The wheel is rotatably connected to the housing. The grating tube is coaxially connected to the wheel and defines at least one transparent area and at least one opaque area.

By means of the transparent area that is made of transparent materials, and the opaque area that is formed by a plurality of opaque layers, the toner cartridge of the present invention is compatible with different types of image-forming apparatuses to reduce manufacturing cost.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a toner cartridge according to a first preferred embodiment of the present invention;

FIG. 2 is an exploded view of the toner cartridge according to the first preferred embodiment of the present invention;

FIG. 3 is a sectional view taken along line 3-3 of FIG. 1;

FIG. 4 is a perspective view of the toner cartridge according to a second preferred embodiment of the present invention, and

FIG. 5 is a perspective view of the toner cartridge according to a third preferred embodiment of the present invention.

### DETAILED DESCRIPTION OF THE INVENTION

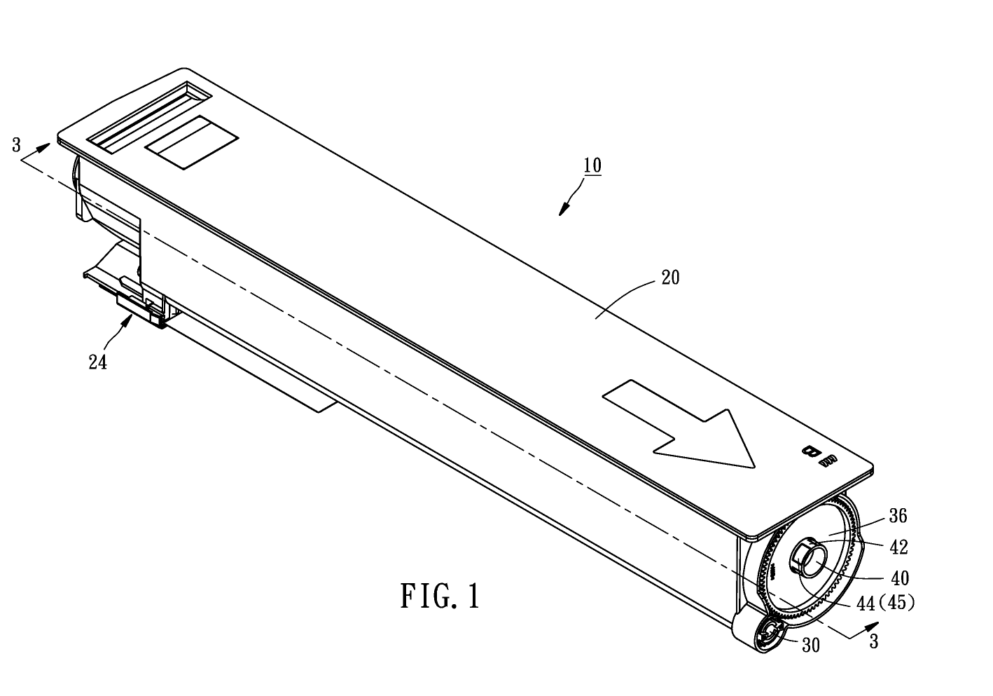

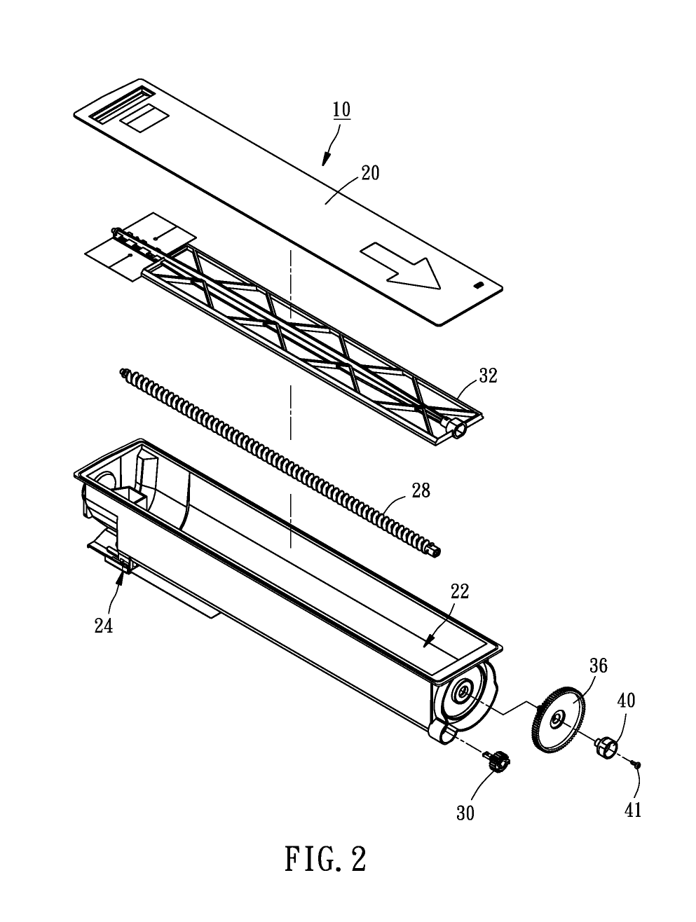

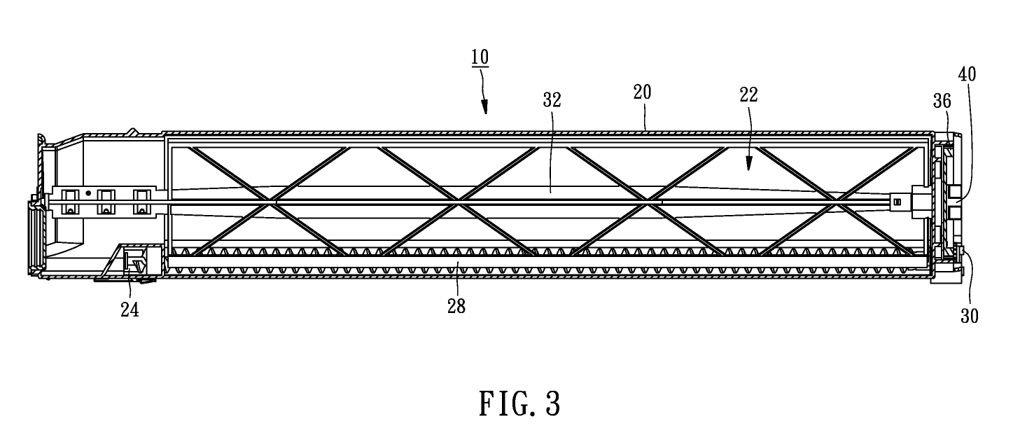

As shown in FIG. 1 to FIG. 3, a toner cartridge 10 in accordance with the first preferred embodiment of the present invention comprises a housing 20, a toner-conveying rod 28, a first wheel 30, an agitating member 32, a second wheel 36, and a grating tube 40.

The housing 20 has a chamber 22 for accommodation of toner (not shown), and an outlet 24 at a left end thereof to be in communication between the chamber 22 and the outside.

The toner-conveying rod 28 is rotatably received in a bottom of the chamber 22 for conveying the toner toward the outlet 24.

The first wheel 30 is rotatably connected to a right end of the housing 20 and coupled to the toner-conveying rod 28 so as to drive the toner-conveying rod 28 to rotate synchronously.

The agitating member 32 is rotatably received in the chamber 22 to agitate the toner for preventing agglomeration of the toner.

The second wheel 36 is rotatably connected to the right end of the housing 20 and coupled to the agitating member 32 for driving the agitating member 32 to rotate synchronously; and further, the second wheel 36 is engaged with the first wheel 30 such that the second wheel 36 can be driven to rotate by the first wheel 30.

When the toner cartridge 10 is installed in an image-forming apparatus (not shown), the first wheel 30 can be rotated by actuation of the image-forming apparatus to drive the toner-conveying rod 28 to convey the toner toward the outlet 24, and to drive the agitating member 32 to agitate the toner through the engagement of the second wheel 36 for preventing agglomeration of the toner.

The grating tube 40 is detachably and coaxially connected to the second wheel 36. In this embodiment, the grating tube 40 is fastened to the second wheel 36 by a bolt 41. The grating tube 40 has four transparent areas 42 and four opaque areas 44, which are staggered with the transparent areas 42. In fact, the grating tube 40 is made of transparent plastic material defining the transparent areas 42 and covered with a plurality of opaque layers 45 defining the opaque areas 44. The opaque layer 45 can be, but not limited to, a sticker, a tape or a coating. The sticker and the tape can be made of opaque or light-reflecting materials, and the coating can be formed by paint, clay, marker pen, etc.

The grating tube 40 can intermittently screen out the light generated from a light emitting element (not shown) through the opaque areas 44 for enabling a light receiving element (not shown) to receive the intermittent light. Therefore, it can be ascertained whether the toner cartridge 10 is working in normal operation. Since the number and the position of the opaque layers 45 are flexible and adjustable easily to match with different types of the image-forming apparatuses, a manufacturer doesn't need to prepare different molds such that the toner cartridge 10 of the present invention has the advantages of flexible application and the manufacturing cost can be reduced.

Furthermore, the grating tube 40 and the second wheel 36 are manufactured individually such that the grating tube 40 can be eliminated according to actual needs, and the grating tube 40 and the second wheel 36 can be replaced singly when the grating tube 40 or the second wheel 36 is damaged, thereby reducing maintenance cost and conforming to the requirement of environment protection. Alternatively, the grating tube 40 and the second wheel 36 can be manufactured integrally.

The toner cartridge can be made with various kinds of design on the basis of the spirit of the present invention. For example, the opaque layers of the grating tube can be replaced by other materials that can absorb, reflect or deflect the light generated from the light emitting element. Besides, the number, the size, and the position of the transparent areas 42 and the opaque areas 44 of the grating tube 40 can be changeable as long as the grating tube 40 is provided with at least one transparent area 42 and at least one opaque area 44. In addition, the number of the wheels that are connected to the housing is unrestricted.

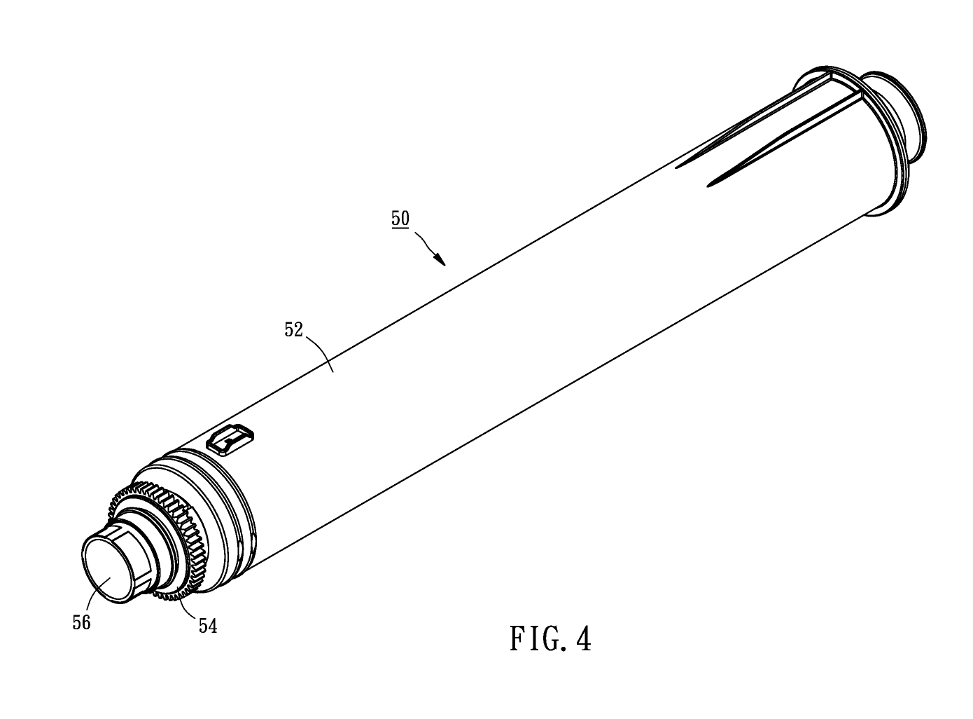

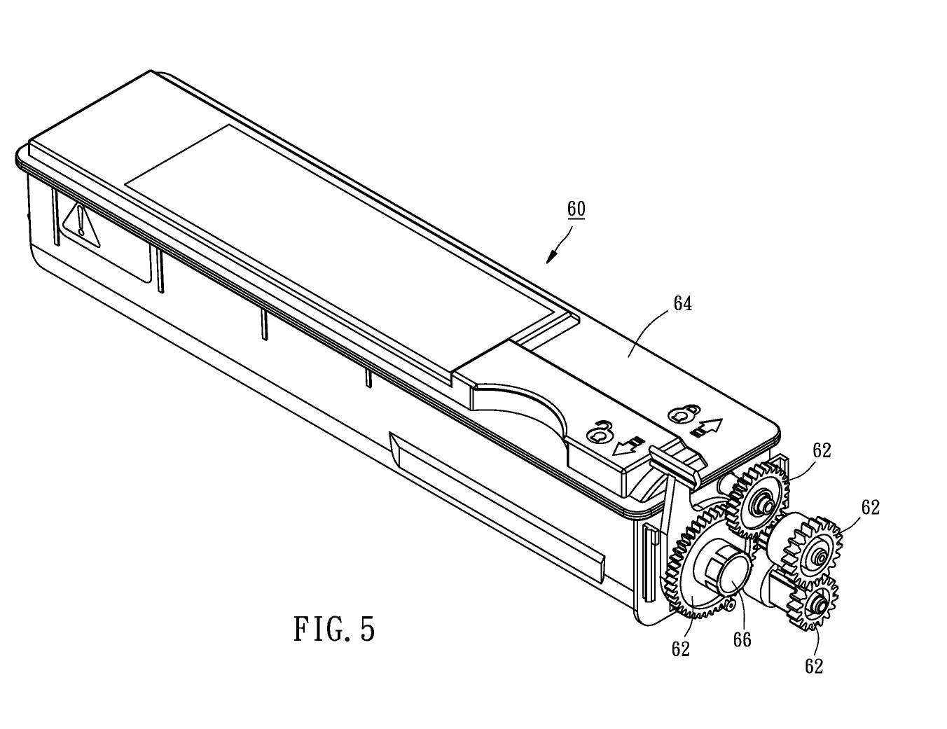

FIG. 4 shows a toner cartridge 50 in accordance with the second preferred embodiment of the present invention. The toner cartridge 50 has only one wheel 54 rotatably connected to the housing 52 for coaxial connection of the grating tube 56. FIG. 5 shows a toner cartridge 60 in accordance with the third preferred embodiment of the present invention, comprising four wheels 62 connected to the housing 64, and a grating tube 66 connected to one of the wheels 62. In fact, the grating tube 66 extends from the wheel 62 integrally.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A toner cartridge comprising:
a housing having a chamber for accommodation of toner, and an outlet in communication between said chamber and the outside;
a wheel rotatably connected to said housing; and
a grating tube coaxially connected to said wheel and defining at least one transparent area and at least one opaque area.

2. The toner cartridge as claimed in claim 1, wherein said grating tube is made of transparent material and covered with at least one opaque layer defining said opaque area.

3. The toner cartridge as claimed in claim 2, wherein said opaque layer is a sticker, a tape or a coating.

4. The toner cartridge as claimed in claim 1, wherein said grating tube is detachably connected to said wheel.

5. A toner cartridge comprising:
a housing having a chamber for accommodation of toner, and an outlet in communication between said chamber and the outside;
a wheel rotatably connected to said housing; and
a grating tube integrally and coaxially extending from said wheel and defining at least one transparent area and at least one opaque area.

6. The toner cartridge as claimed in claim 5, wherein said grating tube is made of transparent material and covered with at least one opaque layer defining said opaque area.

7. The toner cartridge as claimed in claim 6, wherein said opaque layer is a sticker, a tape or a coating.
